(19) United States
(12) Patent Application Publication
(10) Pub. No.: US 2014/0160074 A1
(43) Pub. Date: Jun. 12, 2014

(54) MULTIPLE SENSORS-BASED MOTION INPUT APPARATUS AND METHOD

(71) Applicant: Electronics and Telecommunications Research Institute, Daejeon (KR)

(72) Inventors: Dong-Wan RYOO, Daejeon (KR); Jun-Seok PARK, Daejeon (KR)

(73) Assignee: Electronics and Telecommunications Research Institute, Daejeon (KR)

(21) Appl. No.: 14/028,466

(22) Filed: Sep. 16, 2013

(30) Foreign Application Priority Data
Dec. 12, 2012 (KR) 10-2012-0144163

(51) Int. Cl. G06F 3/042

(52) U.S. Cl. CPC G06F 3/042
USPC 345/175

(57) ABSTRACT

Disclosed herein are a multiple sensors-based motion input apparatus and method. The apparatus includes a transmission unit, a reception unit, a calculation unit, and a control unit. The transmission unit transmits a signal. The reception unit receives a signal that is reflected and enters therein after the signal has been transmitted by the transmission unit. The calculation unit calculates touch location information based on the transmission signal of the transmission unit and the reception signal of the reception unit. The control unit outputs a selection signal corresponding to the touch location information that is calculated by the calculation unit.

### CROSS REFERENCE TO RELATED APPLICATION

This application claims the benefit of Korean Patent Application No. 10-2012-0144163, filed Dec.12, 2012, which is hereby incorporated by reference in its entirety into this application.

### BACKGROUND OF THE INVENTION

1. Technical Field

The present invention relates generally to a multiple sensors-based motion input apparatus and method and, more particularly, to an apparatus and method for inputting motion using a transmission sensor array and a reception sensor array in a non-contact manner.

2. Description of the Related Art

Currently, in certain cases, such as in the case of large-sized displays, the recognition of multi-touches in a non-contact manner is required. Although a camera method has been used to recognize non-contact type touches, the method has the disadvantages of requiring high processing power and being easily affected by the effects of an external environment, such as illumination.

Therefore, there is a need for a technology capable of providing non-contact and bare-hand type motion (multi-touch) recognition, which has a fast response speed, can be embodied at low cost, and is robust to the effects of an external environment.

As a conventional technology, Korean Patent Application Publication No. 10-2005-0086164 discloses a spatial information input apparatus and method that are capable of recognizing information completion signals from a plurality of spatial motions that occur at the same time. The technology disclosed in Korean Patent Application Publication No. 10-2005-0086164 is configured to recognize a plurality of simultaneous finger motions as valid motions in such a manner as to, when detecting a plurality of spatial finger motions, sequentially recognize finger motions a predetermined time after an initial motion point in time. For this purpose, the technology disclosed in Korean Patent Application Publication No. 10-2005-0086164 includes a motion detection unit configured to detect the motions of predetermined bodily portions in the form of predetermined motion signals, and a motion signal processing unit configured to output the motion signals substantially simultaneously detected as valid signals to which specific functions have been assigned.

The technology disclosed in the above-described Korean Patent Application Publication No. 10-2005-0086164 is configured such that motion sensors are worn on fingers and thus a plurality of simultaneous finger motions can be recognized.

As another conventional technology, Korean Patent Application Publication No. 10-2005-0060606 discloses a human computer interaction apparatus and method. The technology disclosed in Korean Patent Application Publication No. 10-2005-0060606 is configured to estimate the three-dimensional (3D) motion of a hand using only a single image sensor. For this purpose, the technology disclosed in Korean Patent Application Publication No. 10-2005-0060606 includes an image sensor configured to acquire an image of a hand from a movement or a motion, a light source configured to project a non-contact type optical mark onto the palm so that the distance between a finger tip to the image sensor can be estimated, and a support configured to support the image sensor on the palm so that the image sensor is prevented from being affected by the motion of a wrist.

The technology disclosed in the above-described Korean Patent Application Publication No. 10-2005-0060606 is configured such that an image sensor is worn on a hand and then spatial displacement input is performed.

### SUMMARY OF THE INVENTION

Accordingly, the present invention has been made keeping in mind the above problems occurring in the conventional art, and an object of the present invention is to provide a multiple sensors-based motion input apparatus and method that are capable of recognizing a user's touches using multiple sensors in a non-contact and bare-hand manner, unlike a conventional camera method.

In accordance with an aspect of the present invention, there is provided a multiple sensors-based motion input apparatus, including a transmission unit configured to transmit a signal; a reception unit configured to receive a signal that is reflected and enters therein after the signal has been transmitted by the transmission unit; a calculation unit configured to calculate touch location information based on the transmission signal of the transmission unit and the reception signal of the reception unit; and a control unit configured to output a selection signal corresponding to the touch location information that is calculated by the calculation unit.

The transmission unit may include any one of ultrasonic sensors, infrared sensors, and laser sensors.

The transmission unit may include elements that are arranged on a frame, side by side in a row.

The reception unit may include elements that are arranged on a frame, side by side in a row along with elements of the transmission unit, the reception unit being disposed adjacent to the transmission unit.

The touch location information may include touch information and touch displacement information; and the calculation unit may calculate the touch information and the touch displacement information using a time difference between the transmission signal of the transmission unit and the reception signal of the reception unit or the amount of reception of the reception unit.

The control unit may recognize a signal under consideration as a click event if the touch location information of the calculation unit has not varied for a predetermined time while a hand has remained on a virtual screen.

The transmission unit and the reception unit may be embedded in the ceiling of the inside of a vehicle.

The transmission unit and the reception unit may be embedded in the floor of a museum near an exhibit.

The transmission unit and the reception unit may be embedded in the floor of an indoor space where a content provision device has been installed, near the content provision device.

In accordance with another aspect of the present invention, there is provided a multiple sensors-based motion input method, including transmitting, by a transmission unit, a signal; receiving, by a reception unit, a signal that is reflected and enters therein after the signal has been transmitted; calculating, by a calculation unit, touch location information based on the transmission signal and the reception signal; and outputting, by a control unit, a selection signal corresponding to the calculated touch location information.

Transmitting the signal may include transmitting a signal using any one of ultrasonic sensors, infrared sensors, and laser sensors.

Transmitting the signal may include arranging any one of ultrasonic sensors, infrared sensors, and laser sensors side by side in a row and then transmitting a signal.

The touch location information may include touch information and touch displacement information; and calculating the touch location information may include calculating the touch information and the touch displacement information using the time difference between the transmission signal and the reception signal or the amount of reception of the signal.

Outputting the selection signal may include recognizing a signal under consideration as a click event if the touch location information has not varied for a predetermined time while a hand has remained on a virtual screen.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of a multiple sensors-based motion input apparatus according to an embodiment of the present invention;

FIG. 2 is a diagram illustrating an example of the installation of the transmission and reception units of FIG. 1;

FIGS. 3 and 4 are diagrams illustrating a case in which the multiple sensors-based motion input apparatus according to an embodiment of the present invention has been mounted on a vehicle;

FIG. 5 is a diagram illustrating a case in which the multiple sensors-based motion input apparatus according to this embodiment of the present invention has been installed in a museum;

FIG. 6 is a diagram illustrating a case in which the multiple sensors-based motion input apparatus according to the embodiment of the present invention is used for a smart TV; and

FIG. 7 is a flowchart illustrating a multiple sensors-based motion input method according to an embodiment of the present invention.

### DESCRIPTION OF THE PREFERRED EMBODIMENTS

The present invention is directed to a non-contact and bare-hand type motion input apparatus and method using sensors in which transmission and reception units that transmit and receive signals in order to calculate touch location information or touch displacement information have been integrated with each other, unlike a conventional camera method. The motion input apparatus and method according to the present invention have a fast response speed because an ultrasonic or laser signal is used as a transmission signal, and may be installed and used in a vehicle because they are robust to external illumination.

A multiple sensors-based motion input apparatus and method according to embodiments of the present invention will be described with reference to the accompanying drawings. Prior to the following detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

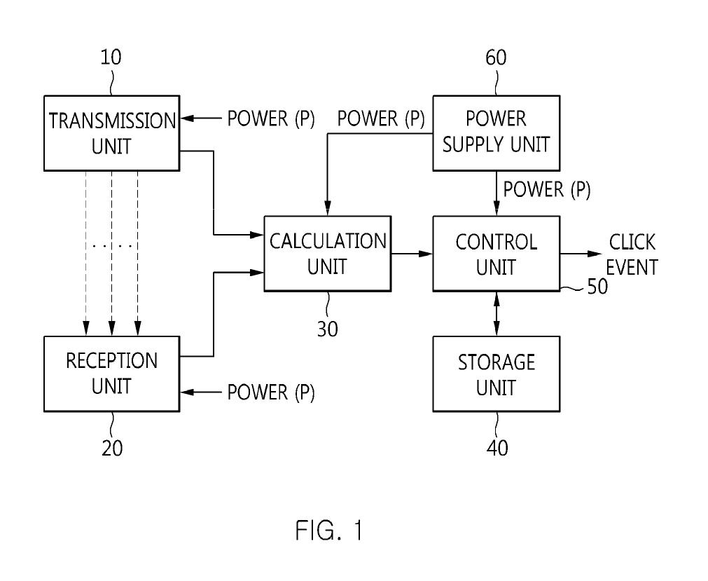

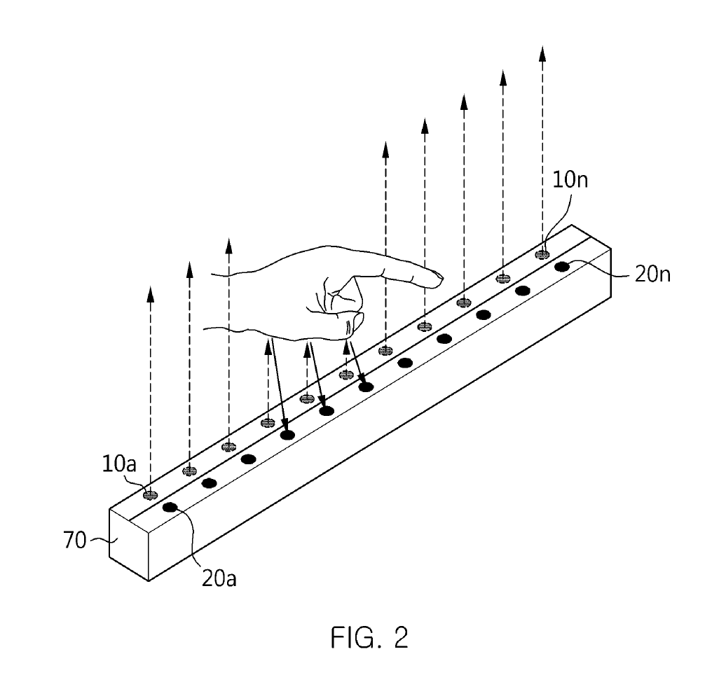

FIG. 1 is a diagram illustrating the configuration of a multiple sensors-based motion input apparatus according to an embodiment of the present invention, and FIG. 2 is a diagram illustrating an example of the installation of the transmission and reception units of FIG. 1.

The multiple sensors-based motion input apparatus according to this embodiment of the present invention includes a transmission unit 10, a reception unit 20, a calculation unit 30, a storage unit 40, a control unit 50, and a power supply unit 60.

The transmission unit 10 transmits a predetermined signal in order to calculate touch location information. Preferably, the transmission unit 10 may use an ultrasonic, infrared, or laser signal as a transmission signal. Accordingly, the transmission unit 10 may include any one of an ultrasonic sensor, an infrared sensor, and a laser sensor.

The reception unit 20 receives a signal that is reflected from a human's hand or the like when the transmission signal of the transmission unit 10 comes into contact with the human's hand or the like. The reception unit 20 is used to calculate touch location information while operating in conjunction with the transmission unit 10.

The elements of the transmission unit 10 and the elements of the reception unit 20 are arranged in a frame 70 of a predetermined length, side by side in two rows in a one-to-one correspondence, as illustrated in FIG. 2. That is, the transmission unit 10 forms an array of a plurality of sensors 10a to 10n, and the reception unit 20 also forms an array of a plurality of sensors 20a to 20n. The number of sensors of the transmission unit 10 is the same as the number of sensors of the reception unit 20. It will be apparent that the number of sensors of the reception unit 20 may be larger than the number of sensors of the transmission unit 10, if necessary. It may be seen that a virtual screen is implemented by the transmission unit 10 and the reception unit 20 that are configured as described above.

The calculation unit 30 calculates touch location information based on the transmission signal of the transmission unit 10 and the reception signal of the reception unit 20. More specifically, the calculation unit 30 calculates touch information (X and Y coordinates) and touch displacement information (∇X and ∇Y) using the time difference between the transmission signal of the transmission unit 10 and the reception signal of the reception unit 20 or the amount of reception (the amount of reflection) of the reception unit 20. In this case, the touch information and the touch displacement information are collectively referred to as “touch location information.”

The storage unit 40 stores data or an application program that is used to operate the multiple sensors-based motion input apparatus according to this embodiment of the present invention.

The control unit 50 outputs a corresponding selection signal based on the touch location information of the calculation unit 30. For example, the control unit 50 recognizes a signal under consideration as a selection signal such as a click event if the touch location information of the calculation unit 30 has not varied for a predetermined time, for example, for one second, while a hand has remained on the virtual screen. Furthermore, if a pair of X and Y coordinates and touch displacement information indicative of the movement of touch from the coordinates are successively input, the control unit 50 determines the X-axis movement (right/left pointing (scroll)) of a mouse and the Y-axis movement (up/down pointing (scroll)) of the mouse based on the pieces of information.

The power supply unit 60 supplies power to the multiple sensors-based motion input apparatus according to this embodiment of the present invention.

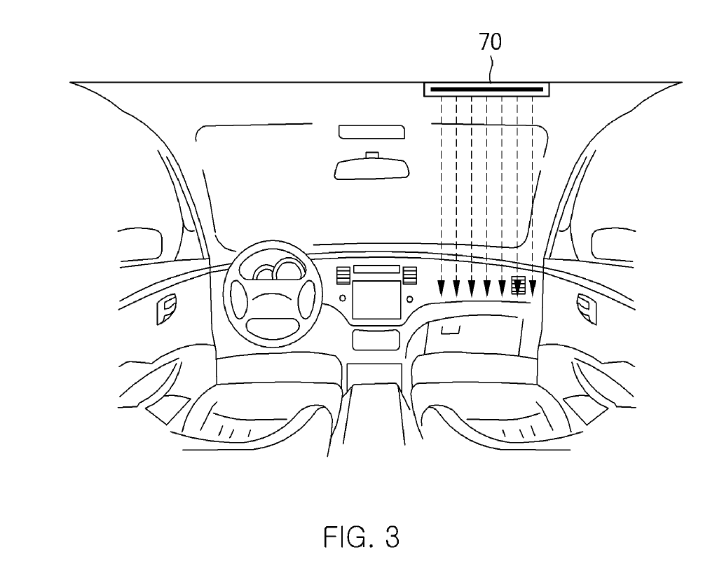

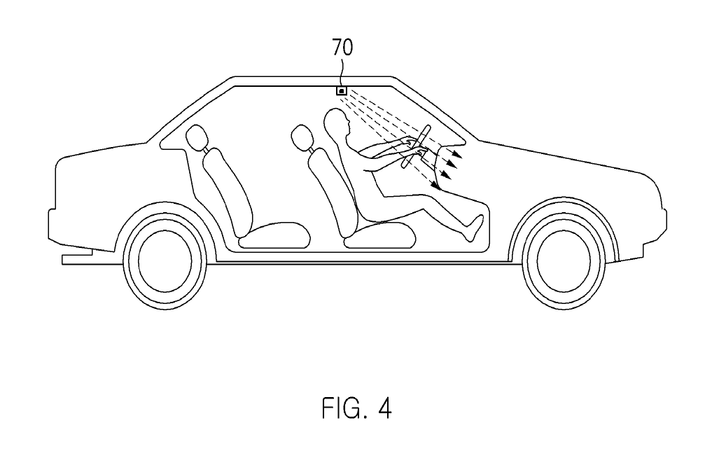

FIGS. 3 and 4 are diagrams illustrating a case in which the multiple sensors-based motion input apparatus according to an embodiment of the present invention has been mounted on a vehicle. FIG. 3 is a diagram illustrating the case in which the multiple sensors-based motion input apparatus according to this embodiment of the present invention has been embedded in a part of a ceiling above the front passenger seat of the vehicle, and FIG. 4 is a side view illustrating the case in which the multiple sensors-based motion input apparatus according to this embodiment of the present invention has been embedded in the ceiling of the vehicle.

The frame 70 in which the elements of the transmission unit 10 and the elements of the reception unit 20 are arranged side by side in two rows in a one-to-one correspondence is mounted in the ceiling above the front passenger seat of the vehicle. The transmission unit 10 and the reception unit 20 are oriented toward the front window of the vehicle in an inclined manner so that a user seated in the front passenger seat can conveniently use it.

This enables the user seated in the front passenger seat to manipulate a navigation device, a multimedia device, a head-up display (HUD), and the like in front of him or her with his or her hand.

As illustrated in FIGS. 3 and 4, the multiple sensors-based motion input apparatus according to this embodiment of the present invention is robust to the effects of an external environment (such as illumination), and thus it may be mounted on the ceiling of a vehicle and used as an interface for a smart car.

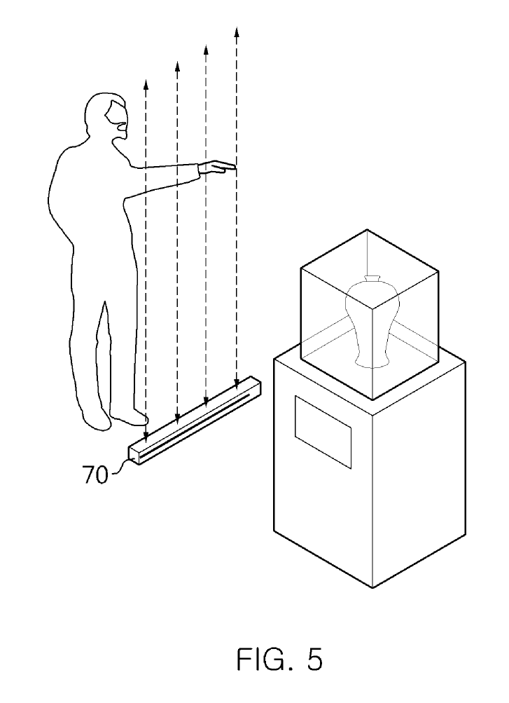

FIG. 5 is a diagram illustrating a case in which the multiple sensors-based motion input apparatus according to this embodiment of the present invention has been installed in a museum.

In FIG. 5, the frame 70 in which the elements of the transmission unit 10 and the elements of the reception unit 20 are arranged side by side in two rows in a one-to-one correspondence is embedded in the floor of the museum near an exhibit in the museum.

This enables a user to manipulate a multimedia device for giving an explanation of the exhibit by using his or her hand.

As illustrated in FIG. 5, the multiple sensors-based motion input apparatus according to this embodiment of the present invention may be embedded in the floor of a museum, an exhibition hall, or the like etc. and be used to manipulate or control a multimedia device.

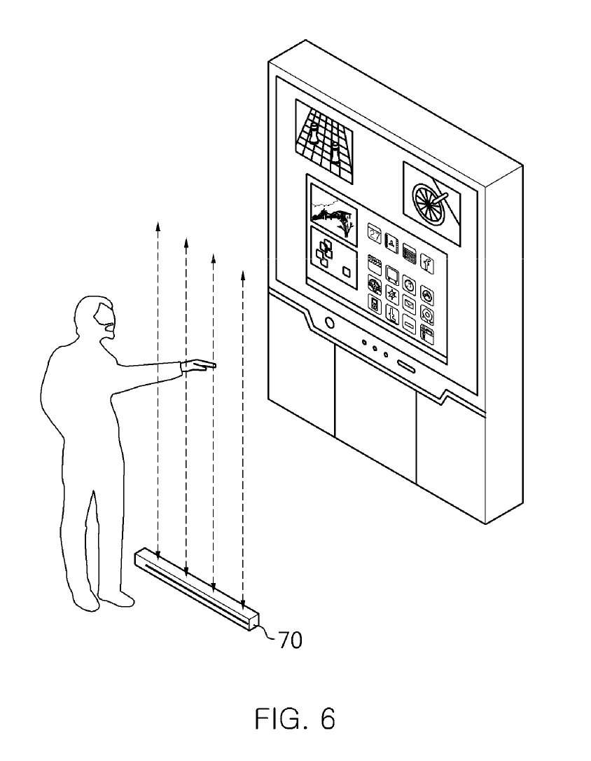

FIG. 6 is a diagram illustrating a case in which the multiple sensors-based motion input apparatus according to this embodiment of the present invention is used for a smart TV.

In FIG. 6, the frame 70 in which the elements of the transmission unit 10 and the elements of the reception unit 20 are arranged side by side in two rows in a one-to-one correspondence is embedded in the floor of an indoor space where a content provision device, such as a smart TV, is installed, near the content provision device.

This enables a user to manipulate content that is provided by the smart TV with his or her hand.

As illustrated in FIG. 6, the multiple sensors-based motion input apparatus according to this embodiment of the present invention may be embedded in a floor in a large-sized display environment for a home or an office, and may be used to manipulate or control multimedia.

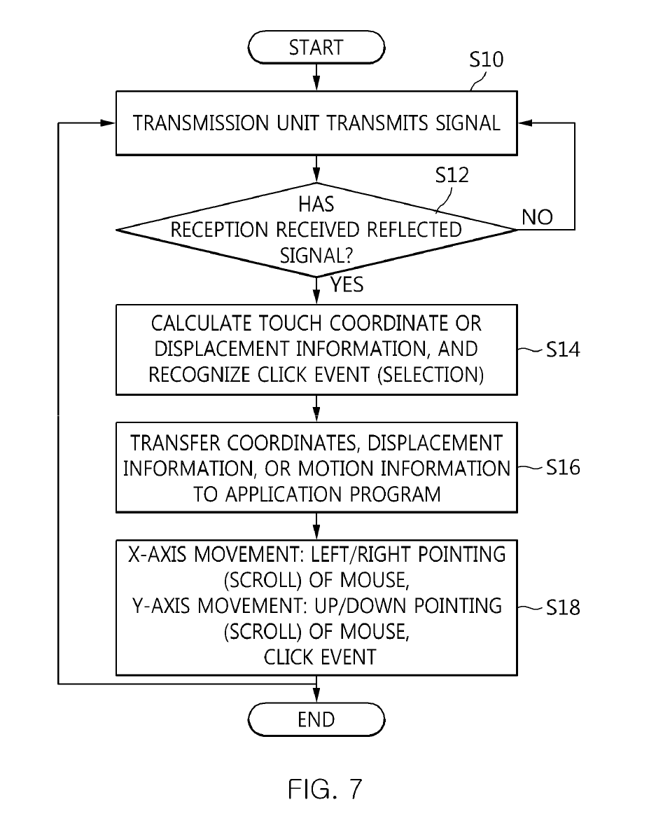

FIG. 7 is a flowchart illustrating a multiple sensors-based motion input method according to an embodiment of the present invention.

In the state in which the all sensors of the transmission unit 10 and the reception unit 20 have been initialized, the transmission unit 10 transmits a signal, such as an ultrasonic, laser, or infrared signal at step S10.

Thereafter, the reception unit 20 receives a signal that is reflected and enters therein. If the reception unit 20 has received the signal that was reflected and entered therein (YES at step S12), the reception unit 20 transfers the reception signal to the calculation unit 30.

Thereafter, the calculation unit 30 calculates touch information (X and Y coordinates) and touch displacement information (∇X and ∇Y) using the time difference between the transmission signal of the transmission unit 10 and the reception signal of the reception unit 20 or the amount of reception (the amount of reflection) of the reception unit 20. Furthermore, the control unit 50 recognizes a selection signal, such as the X-axis movement (left/right pointing (scroll)) of a mouse, the Y-axis movement (up/down pointing (scroll)) of a mouse, or a click event, based on the touch information and the touch displacement information that are calculated by the calculation unit 30 at step S14.

Thereafter, the control unit 50 applies the touch information and touch displacement information calculated by the calculation unit 30 to an application program of the storage unit 40 at step S16.

Accordingly, the X-axis movement (right/left pointing (scroll)) of the mouse, the Y-axis movement (up/down pointing (scroll)) of the mouse, the click event or the like is executed in accordance with the information calculated by the calculation unit 30 at step S18.

The present invention is advantageous in that the apparatus according to the present invention may be embedded in a vehicle, an exhibition hall, or a large-sized display in the form of an apparatus for receiving sensor-based motion input and receives user input in a non-contact manner, thereby providing user-friendly convenience.

That is, the apparatus according to the present invention can recognize the touches (multi-touches) of a user's hand in a non-contact and bare-hand manner, and the apparatus according to the present invention has low computational load and a fast response speed because it is of a sensor type, not of a camera type. Furthermore, the apparatus according to the present invention can be embodied using a microcontroller unit (MCU)-level small-sized processor at low cost because its computational load is low, and it can be implemented to have high precision because its resolution can be increased.

Meanwhile, the apparatus according to the present invention can be used inside a vehicle during the daytime because it is robust to the effects of an external environment (such as illumination), and the apparatus according to the present invention can be easily installed because its transmission and reception units are integrated into a single body.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multiple sensors-based motion input apparatus, comprising:
a transmission unit configured to transmit a signal;
a reception unit configured to receive a signal that is reflected and enters therein after the signal has been transmitted by the transmission unit;
a calculation unit configured to calculate touch location information based on the transmission signal of the transmission unit and the reception signal of the reception unit; and
a control unit configured to output a selection signal corresponding to the touch location information that is calculated by the calculation unit.

2. The multiple sensors-based motion input apparatus of claim 1, wherein the transmission unit comprises any one of ultrasonic sensors, infrared sensors, and laser sensors.

3. The multiple sensors-based motion input apparatus of claim 2, wherein the transmission unit comprises elements that are arranged on a frame side by side in a row.

4. The multiple sensors-based motion input apparatus of claim 1, wherein the reception unit comprises elements that are arranged on a frame side by side in a row along with elements of the transmission unit, the reception unit being disposed adjacent to the transmission unit.

5. The multiple sensors-based motion input apparatus of claim 1, wherein:
the touch location information comprises touch information and touch displacement information; and
the calculation unit calculates the touch information and the touch displacement information using a time difference between the transmission signal of the transmission unit and the reception signal of the reception unit or an amount of reception of the reception unit.

6. The multiple sensors-based motion input apparatus of claim 1, wherein the control unit recognizes a signal under consideration as a click event if touch location information of the calculation unit has not varied for a predetermined time while a hand has remained on a virtual screen.

7. The multiple sensors-based motion input apparatus of claim 1, wherein the transmission unit and the reception unit are embedded in a ceiling of an inside of a vehicle.

8. The multiple sensors-based motion input apparatus of claim 1, wherein the transmission unit and the reception unit are embedded in a floor of a museum near an exhibit.

9. The multiple sensors-based motion input apparatus of claim 1, wherein the transmission unit and the reception unit are embedded in a floor of an indoor space where a content provision device has been installed, near the content provision device.

10. A multiple sensors-based motion input method, comprising:
transmitting, by a transmission unit, a signal;
receiving, by a reception unit, a signal that is reflected and enters therein after the signal has been transmitted;
calculating, by a calculation unit, touch location information based on the transmission signal and the reception signal; and
outputting, by a control unit, a selection signal corresponding to the calculated touch location information.

11. The multiple sensors-based motion input method of claim 10, wherein transmitting the signal comprises transmitting a signal using any one of ultrasonic sensors, infrared sensors, and laser sensors.

12. The multiple sensors-based motion input method of claim 11, wherein transmitting the signal comprises arranging any one of ultrasonic sensors, infrared sensors, and laser sensors side by side in a row and then transmitting a signal.

13. The multiple sensors-based motion input method of claim 10, wherein:
the touch location information comprises touch information and touch displacement information; and
calculating the touch location information comprises calculating the touch information and the touch displacement information using a time difference between the transmission signal and the reception signal or an amount of reception of the signal.

14. The multiple sensors-based motion input method of claim 10, wherein outputting the selection signal comprises recognizing a signal under consideration as a click event if the touch location information has not varied for a predetermined time while a hand has remained on a virtual screen.
